(19) United States
(12) Patent Application Publication
(10) Pub. No.: US 2024/0261194 A1
(43) Pub. Date: Aug. 8, 2024

(54) FIXING DEVICE FOR DOUBLE-TUBE INTUBATION

(71) Applicants: West China Hospital, Sichuan University, Chengdu (CN); Chengdu Lize Technology Co., Ltd., Chengdu (CN)

(72) Inventors: Yan JIANG, Chengdu (CN); Yan LIU, Chengdu (CN); Wei CUN, Chengdu (CN); Menghang WU, Chengdu (CN); Hua CAO, Chengdu (CN); Dayong WU, Chengdu (CN); Qijie HUANG, Chengdu (CN)

(73) Assignees: West China Hospital, Sichuan University, Chengdu (CN); Chengdu Lize Technology Co., Ltd., Chengdu (CN)

(21) Appl. No.: 18/641,887

(22) Filed: Apr. 22, 2024

Related U.S. Application Data
(63) Continuation of application No. PCT/CN2023/081764, filed on Mar. 16, 2023.

(30) Foreign Application Priority Data
Dec. 30, 2022 (CN) 202211726762.0

(51) Int. Cl. A61J 15/00

(52) U.S. Cl. CPC A61J 15/0061

(57) ABSTRACT

A fixing device for double-tube intubation includes a fitting component and a fixing frame arranged on the fitting component, where both ends of the fitting component are connected with a connecting portion, through which the fitting component is fixed to philtrum below nares. The fixing frame includes at least two pressing portions, one side of each of the pressing portions is connected mutually while the other side is mutually and detachably connected, and containing portions for placing the pipeline are arranged between the two pressing portions.

### CROSS-REFERENCE TO RELATED APPLICATION

This application is a continuation of International Application No. PCT/CN2023/081764, filed on Mar. 16, 2023, which claims priority to Chinese Patent Application No. 202211726762.0, filed on Dec. 30, 2022. The disclosures of the above-mentioned applications are hereby incorporated by reference in their entireties.

### TECHNICAL FIELD

The present disclosure relates to the field of medical devices, and in particular to a fixing device for double-tube intubation.

### BACKGROUND

A nasal feeding nutrition catheter (also known as a nasointestinal tube) made of a high polymer material is a medical device, which is intubated from a nasal cavity, reaches the duodenum or jejunum through the pharyngeal, esophagus and stomach, is used for enteral nutrition infusion, and plays an important role in nutritional support for patients. Using the nasointestinal tube to infusing the nutrient solution from the nasal cavity has become a widely used clinical nursing and operation technique, and is a necessary and important medical technical means to ensure that comatose patients, vegetative patients or patients not eating orally due to digestive tract diseases such as the esophagus cancer, esophageal stenosis, laryngocarcinoma and hypopharyngeal carcinoma can intake enough nutrition during their treatment to maintain the physical health.

According to “T/CNAS20-2021 Intubation and Maintenance of Nasointestinal Tube in Adult Patients” and the nursing technical practice code “Nursing Practice Guideline for Enteral Nutrition in Patients with Stroke” (2021), the clinically used nasointestinal tube is fixed by adopting a platform aloft method. The platform aloft method is that the pipeline intubated from the nasal cavity is directly affixed to both sides of the patient's alar and the cheek for pipeline fixation after being intersected by a medical tape, to ensure that the nasointestinal tube intubated into the nasal cavity is accurately positioned in vivo and can work normally. The quality of the adhesive substance affixed to the tape as well as the tissue structure and thread count of a fabric are important parameters for controlling the quality of a tape product, and directly affect the using effect of the platform aloft method of the nasointestinal tube; and the cleanliness of the head and face skin of the patient and the operation skill of an operator are also important factors affecting the fixation and positioning of the nasointestinal tube. Since the pipeline is directly affixed to the skin surface of the patient by adopting the tape, the patient's skin allergy, sweat influence, posture movement and weak tape adhesion will all cause that the tape cannot be cling to the skin, is easy to upwarp and loosen, thus occurring a shift for the pipeline fixation, causing infection and injury, affecting the treatment effect, even leading to the pipeline slip to become the serious adverse event with the medical risk.

The fixation for the nasointestinal tube is the concerned key and difficult points in the nursing technical operation training and the enteral nutrition treatment. To avoid the occurrence of the adverse event such as the patient's skin allergy and infection, clinical nursing has strict regulations on nasointestinal tube in indwelling, extubation, complication prevention and treatment, requiring: the adhesive tape and the fixing position thereof are replaced every 24-48 h, and the catheter must be adjusted or replaced in time for a damp, a looseness or a shift. These frequent daily operations increase the nursing labor intensity, aggravate the workload of the nursing management, and even affect the treatment experience of the patient.

The traditional method for fixing the nasointestinal tube by adopting the platform aloft method needs to cut the tape, with repeated pasting, complex operation and time consuming, the fixing effect replies on the hand feeling and experience of the operator, the fixing tape on the cheek needs to be torn down when the nasointestinal tube is replaced regularly, the patient has a strong pain, thus affecting the treatment experience, and using the tape to fix the nasointestinal tube for a long time will also lead to skin allergy. In view of the quality difference of the tape products from different manufacturers, due to the influence of the patient's face, especially alar secretion, long-time tape adhesion, operation experiences of clinical staff and other reasons, the common issues for fixing the nasointestinal tube clinically include: time consuming for fixation, complex operation, pipeline shift, pipeline slip, blockage by foreign matters, poor circulation, end cracking, extraction difficulty and the like, in particular, the pipeline shift and slip are the most common, which may cause secondary harm to the patient, occur the non-medical extubation, seriously affect the effectiveness of treatment, and has become the main factors for poor events such as the medical safety hazard and the occurrence of an infection. During regular nasal feeding operation, the tail end of the nasointestinal tube needs to be lifted for infusion, the tape affixed to the cheek needs to be torn and affixed repeatedly, which easily causes the skin discomfort or injury of the patient, and the above-mentioned clinical pain points have become the issues that confuse clinical for a long time and are not solved well.

The patent No. CN211536105U discloses a fixator intubated through a nasal tracheal tube, a nasal intubation tube is arranged on a cushion to clamp and fix the tracheal tube, both sides of the cushion are connected with elastic bands with ear bands, and the fixator is hung to the patient's ears through the ear bands, thus achieving the fixation for the fixator. Due to the elastic action of the elastic bands, the ear bands generate a relatively great extrusion force to the patient's ears, and long-term wearing will cause damage to the ears.

The patent No. CN205964508U discloses a spectacle frame type fixing device for a nasal feeding tube, a pipeline passes through a fixing tube mounted on the spectacle frame, and the pipeline is prevented from moving axially along the fixing tube by tightening screws mounted on side walls of the fixing tube, thus fixing and positioning. In this technical solution, the dependence for fixing the pipeline with the tape and the fixing mode with the elastic bands and the ear bands in the above patent are got rid of, and the patient's discomfort due to wearing the fixing device is alleviated; however the fixing tube is supported with the help of the spectacle frame in this patent, the patient wears the spectacle at auricle for fixation, the fixation and positioning for the crucial pipeline at the nares are not considered, and when the patient feels discomfort and a posture movement occurs, the pipeline shift is very easily caused. The fixation with the wearing spectacle frame cannot ensure the positioning stability of the nasointestinal tube.

The patent No. CN215135581U discloses a fixing band intubated through a nasal cavity, a movable block capable of rotating is arranged in this solution, the movable block cooperates with a stationary fixing block to clamp and fix the pipeline at nares, where the fixing mode for the movable block and the fixing block adopts a fixture block that is clamped in a limiting slot, and this fixing mode is not suitable for fixing the pipeline of different pipe diameters, which limits the using scope of the fixing device and brings inconvenience to clinical operation.

The patent No. CN215308505U discloses a fixing device for a nasal feeding tube, a restraint band is pressed on a bump to fix a pipeline placed on the bump, where the restraint band adopts a hook to catch hanging rails for implementing fixation, and two hanging rails are provided, such that the restraint band may regulate a pressing-down force, thus fixing the pipeline of different pipe diameters. In this technical solution, both sides of a first support sheet are provided with connecting bands to fix the fixing device, the pipeline located outside the nares cannot be arranged towards the cheek along the connecting bands, when the patient's posture is changed, the pipeline part, not fixed, is easy to cause shift, slip, even deepen a mechanical stimulation or a secondary injury to the patient's nasal cavity, thus existing a certain safety hazards.

The patent No. CN215308505U provides an ear-hanging fixator for a nasointestinal tube, a pipeline is fixed through elastic bands hung on a patient's ears and a fluorescent sheet is arranged on a base body, which solves issues of the pipeline fixed to the nares and observation of a shift at night, but during long-term use, under the tension action of the elastic bands, the discomfort of the patient's auricle aggravates, even generating a facial crush, causing dysphoria and resistance to use. In this solution, the pipeline enters the nasal cavity through a plugging hole in a support sheet, which increases the operation complexity, although the pipeline is fixed to the nares, the rest of the longer pipeline part cannot still be fixed effectively, when a posture movement of a patient occurs, the unfixed pipeline part generates a swing, which will increase the friction of the support sheet to the patient's nares, thus affecting the patient experience; and meanwhile the support sheet arranged closely to the patient's nares prevents the air inflowing, which also affects the smooth breathing of the patient to some extent. This ear-hanging fixator is not only complex in operation, but also cannot meet the treatment experience and compliance requirement of a clinical patient.

The patent No. CN217162661U discloses a nasal mask type fixator preventing a nasal feeding tube from falling, a structure for containing a semi-ring is arranged on an arc-shaped nasal mask to contain a pipeline located outside nares, and the pipeline is easy to fall out of the contained semi-ring, cannot achieve the fixing effect of a platform aloft method well or reach the treatment requirement.

The patent No. CN216877228U discloses a fixing device for a nasogastric tube and the nasogastric tube, a pipeline is clamped and fixed through a clamping portion on a positioning tube, but the pipeline of different pipe diameters is subjected to different clamping forces in an axial direction of the positioning tube for fixing the pipe diameter, the pipeline will occur a displacement with the posture change of the patient, causing slip and displacement of the pipeline from nares, even deepening a secondary injury to the patient, thus existing a certain safety hazards.

### SUMMARY

For the issue that a pipeline for enteral nutrition by infusing a nutrient solution through nasal cavity intubation in the above-mentioned tape adhering, wearing, ear-handing and other solutions has a poor fixing effect, the objective of the present disclosure is to provide a fixing device for double-tube intubation, a fitting component with a fixing frame is fixed to philtrum below nares through a connecting portion, an intubation tube is clamped and fixed through a relative movement of two pressing portions of the fixing frame, such that the pipeline intubated to the nasal cavity keeps stable and unloosened at the nares, thus effectively avoiding a pipeline displacement or slip when a patient's posture moves.

Embodiments of the present disclosure are achieved by the following technical solution.

A fixing device for double-tube intubation includes a fitting component and a fixing frame arranged on the fitting component, where both ends of the fitting component are connected with a connecting portion, through which the fitting component is fixed to philtrum below nares, the fixing frame includes at least two pressing portions, one end of each of the pressing portions is connected mutually while the other end is in mutual opening and closing connection, and containing portions for placing an intubation pipeline are arranged between the two pressing portions.

Preferably, at opening and closing connecting ends of the pressing portions, one end of one of the pressing portions is equipped with latches, and one end of the other pressing portion is equipped with a fixture block that fits with the latches and is in opening and closing connection.

Preferably, the two pressing portions are arranged in a form of upper and lower structures, and divided into an upper pressing portion and a lower pressing portion.

A pressing section of the upper pressing portion is wavy and formed with two arc-shaped upper pressing slots with downward openings; and the lower pressing portion is provided with a base, correspondingly to each upper pressing slot of an upper pressing section, the base is provided with a corresponding arc-shaped lower pressing slot, and the upper pressing slots and the lower pressing slots form the containing portions for placing the intubation pipeline.

A link that is lower than a lower pressing notch portion is arranged between the two lower pressing slots of the lower pressing portion, both ends of the base are provided with protrusion portions raised upwards, a plurality of connecting seats are arranged on the fitting component and provided with plugging holes, both ends of the base connected with the fitting components is clamped and fixed through the protrusion portions after passing through the plugging holes of the connecting seats, another connecting seat is also provided between the above two connecting seats, and the lower pressing portion passes through the plugging hole of the another connecting seat from one end, such that the link is clamped with the another connecting seat, thus fixing the pressing portions from the middle of the base.

Preferably, a plurality of latches are provided.

Preferably, one end of each of the pressing portions that is away from the opening and closing connection end is hinged or elastically connected.

Preferably, a pressing column is arranged inside one pressing portion and at least two groups of limiting columns are arranged inside the other pressing portion, both the pressing column and the limiting columns are protruded from the containing portions, and the pressing column is located between the two groups of limiting columns.

Preferably, the connecting portion includes strip plates connected with the fitting component, and the strip plates are connected with bandages.

Preferably, bending portions are arranged in the strip plates and extend to auricle.

Preferably, the strip plates are connected with at least one limiting member, and a channel, through which the intubation pipeline passes, is arranged in the limiting member.

Preferably, one side of the limiting member is provided with an opening.

Preferably, at least two limiting members are provided, and openings of the limiting members are located on both sides of the strip plates in respective.

Preferably, one pressing portion is detachably connected with the fitting component, and the strip plates are detachably connected with the fitting component.

Preferably, a plurality of connecting seats are arranged on the fitting component and provided with the plugging holes, both ends of the pressing portions connected with the fitting component are provided with second protrusion portions after passing through the plugging holes, and one end of each of the strip plates that is connected with the fitting component is provided with a first protrusion portion after passing through the plugging holes.

Preferably, the containing portion is obliquely arranged along a direction of nares.

Preferably, the fitting component is made of silica gel.

The technical solution of the embodiments in the present disclosure at least has the following advantages and beneficial effects.

1. The fitting component with the fixing frame is fixed to the philtrum below the nares through the connecting portion, the pipeline inserted from the nasal cavity is clamped and fixed through the relative movement of the two pressing portions of the fixing frame, and the pipeline is mounted simply and quickly and positioned accurately and stably, thus effectively avoiding the pipeline shift or slip when the patient's posture changes.

2. The latches and fixture block are arranged, such that the two pressing portions are fixed by the latches and the fixture block after being mutually fitted, with a simple structure and convenient operation.

3. The fixture block may be clamped and fixed to different latches by setting a plurality of latches, thus regulating the fitting degree of the two pressing portions, the fixing device may be suitable for different pipe diameters, particularly fixing the pipeline of small pipe diameter, and a greater static pressure is further applied to the pipeline, to increase the fixing effect.

4. The two hinged or elastically connected pressing portions may rotate around one end, thus pressing and fixing the pipeline, and however the elastic connecting mode may achieve the automatic pop-out of one pressing portion, thus taking out the pipeline conveniently.

5. The two groups of limiting columns are arranged to limit the position of the pipeline, such that the pipeline cannot swing left and right, and then the pipeline is pressed and fixed through the pressing column, thus further increasing the fixing effect of the pipeline.

6. During use, the hard strip plates are located on both sides of the cheek in respective, to reduce the swing of the fitting component, the whole fixing device is fixed to the patient's head through the bandages, the fixing device may move synchronously along the head swing or posture movement, further ensuring that the fixing device can be stably fitted to the philtrum below the nares without displacing.

7. The fixing device for the bandages is guided above the auricle through the bending portions of the strip plates, such that the bandages may be limited by the auricle after being bundled and fixed, to avoid the displacement generated by the fixing device due to the moving-down of the bandages.

8. The rest of the longer pipeline part may pass through the limiting member and is arranged on both sides of the cheek by setting the limiting member, to avoid the friction generated by the unfixed pipeline part with the patient's nares or face when the patient's posture changes, the patient feels discomfort, thus increasing the treatment compliance.

9. The limiting member is provided with an opening, the intubation pipeline may be pressed from the side of the limiting member to enter the pipeline of the limiting member, such that the arrangement for the pipeline is easier and labor-saving, saves time and conforms to the nursing requirements.

10. After the pipeline is limited by the two limiting members with inconsistent opening positions, the pipeline may be prevented from sliding from the opening on the same side after being subjected to an external force, thus ensuring the limiting effect of the limiting members on the pipeline.

11. The pressing portion and the strip plates are detachably connected to the fitting component, thus disassembling the fixing frame, the fitting component and the connecting portion conveniently.

12. The first protrusion portion and the second protrusion portion are arranged, such that the pressing portion and the strip plates can play a fixing and limiting role after passing through the connecting seats, and setting this detachable structure enables the mounting and disassembly to be more convenient.

13. The containing portions are set to be a certain inclination to aim at the nares, which greatly reduces the mechanical stimulation of intubation to the nasal cavity, and reduces the foreign body sensation caused by the pipeline bending during intubation, such that the nasal feeding intubation operation is more humanized.

14. The fitting component is made of silica gel, which also improves the skin comfort of the patient while ensuring a better static friction force.

### BRIEF DESCRIPTION OF THE DRAWINGS

To better clarify the technical solution of the embodiments of present disclosure, the drawings required to illustrate the embodiments of present disclosure will be simply described below. It is understood that the drawings described below merely illustrate some embodiments of present disclosure, so it is not a limitation to the scope. Those ordinarily skilled in the art can obtain other related drawings of other embodiments without creative labor on the basis of those drawings.

FIG. 1 is a structure schematic diagram provided by embodiments of the present disclosure.

FIG. 2 is an enlarge schematic diagram of part A in FIG. 1.

FIG. 3 is a schematic diagram of a side-looking structure provided by embodiments of the present disclosure.

FIG. 4 is a structure schematic diagram of a connecting portion provided by embodiments of the present disclosure.

FIG. 5 is a connecting structure schematic diagram of two pressing portions provided by another embodiment of the present disclosure.

FIG. 6 is a structure schematic diagram of a connecting portion provided by another embodiment of the present disclosure.

FIG. 7 is an enlarged drawing of a fitting component and a fixing frame in the present disclosure.

### DETAILED DESCRIPTION OF THE EMBODIMENTS

In order to make the objectives, technical solution and advantages of the present disclosure clearer, the technical solutions in the embodiments of the present disclosure are clearly and completely elaborated below in combination with the drawings. It is apparent that the described embodiments are a part of the embodiments of the present disclosure but not all. Usually, the components of embodiments of the present disclosure described and shown in the drawing here may be arranged and designed in various configurations.

Therefore, the detail description for the embodiments of the present disclosure provided in the drawings below is not intended to limit the protection scope of the present disclosure, and merely shows the selected embodiments of the present disclosure. Based on the embodiments of the present disclosure, all the other embodiments obtained by those of ordinary skill in the art on the premise of not contributing creative effort should belong to the protection scope of the present disclosure.

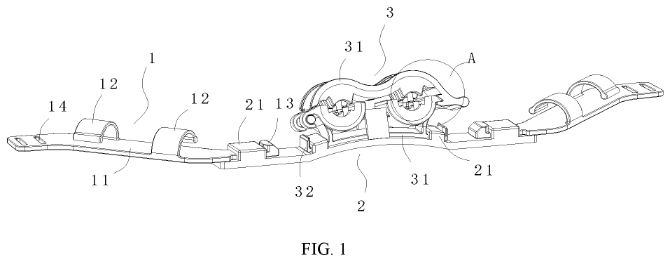

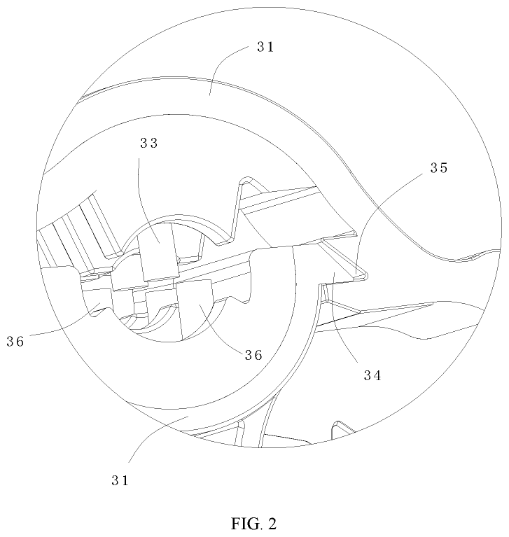

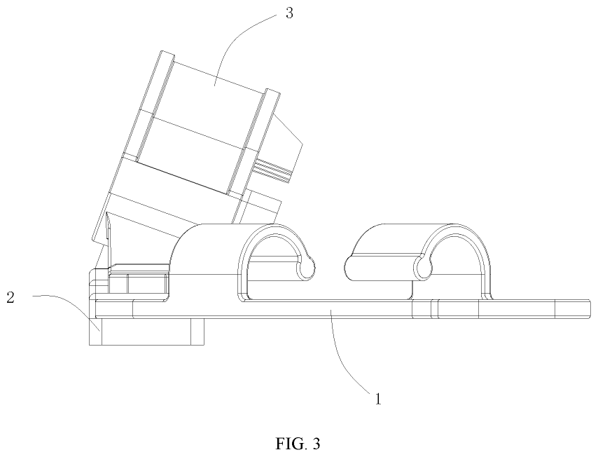

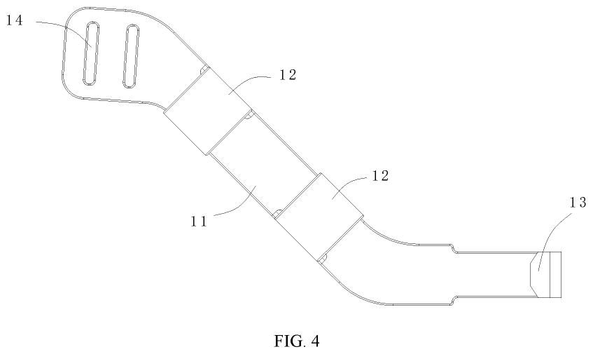

The present disclosure is further described in detail below in combination with FIG. 1 to FIG. 6.

A fixing device for double-tube intubation includes a fitting component 2 and a fixing frame 3 arranged on the fitting component 2, where both ends of the fitting component 2 are connected with a connecting portion 1, through which the fitting component 2 is fixed to philtrum below nares, the fixing frame 3 includes at least two pressing portions 31, one end of each of the pressing portions 31 is connected mutually while the other end is in mutual opening and closing connection, and containing portions for placing an intubation pipeline are arranged between the two pressing portions 31.

Two containing portions for placing the pipeline during intubation are provided, each containing portion aims at the nares to fix different pipelines, that is, fix a nasointestinal tube, an oxygen tube or other pipelines entering the body through the nasal cavity. During fixation, the pipeline may be flexibly fixed according to the positions that the pipeline is inserted into the left and right nares, and the fixing device is not required to be adjusted frequently, which is convenient to operate, and saves time.

The fitting component 2 may be made into a hard fitting structure or a soft deformable fitting structure, where the soft deformable fitting structure may adapt to different patients to fit with the philtrum better, with a stronger practicability, and therefore the fitting component 2 is preferably made of the soft material.

Silicone mats are arranged inside the containing portions, and a greater static friction force may generate through the contact between the silicon mats and the pipeline, thus effectively reducing the axial slip of the pipeline along the containing portions.

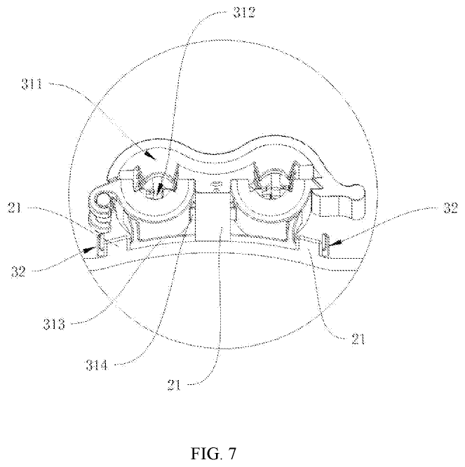

In this embodiment, as shown in FIG. 1 and FIG. 7, the two pressing portions are arranged in a form of upper and lower structures, and divided into an upper pressing portion and a lower pressing portion.

A pressing section of the upper pressing portion is wavy and formed with two arc-shaped upper pressing slots 311 with downward openings; and the lower pressing portion is provided with a base 313, correspondingly to each upper pressing slot of an upper pressing section, the base is provided with a corresponding arc-shaped lower pressing slot 312, and the upper pressing slots 311 and the lower pressing slots 312 form the containing portions for placing the intubation pipeline.

A link 314 that is lower than a lower pressing notch portion is arranged between the two lower pressing slots of the lower pressing portion, both ends of the base are provided with second protrusion portions 32 raised upwards, a plurality of connecting seats 31 are arranged on the fitting component and provided with plugging holes, both ends of the base connected with the fitting components is clamped and fixed through the protrusion portion after passing through the plugging holes of the connecting seats, another connecting seat is also provided between the above two connecting seats, and the lower pressing portion passes through the plugging hole of the another connecting seat from one end, such that the link 314 is clamped with the another connecting seat, thus fixing the pressing portions from the middle of the base. During actual production and application, the fitting component 2 is made of a soft material while the pressing portions are made of hard materials, therefore various components need to be manufactured independently, and setting the connecting seat structure for the plugging hole and the base connecting structure is not only convenient for assembly, but also effectively fixes the fitting component and the pressing portions.

In this embodiment, one end of one of the pressing portions 31 is equipped with latches 35, and one end of the other pressing portion 31 is equipped with a fixture block 34 that fits with the latches 35 and is in detachable connection, and a plurality of latches 35 are provided. The two pressing portions 31 are fixed by setting the fixture block 34 and the plurality of latches 35, and the degree of compaction of the pressing portions 31 is adjusted according to the situation, with a simple and quick operation.

One end of each of the pressing portions 31 that is away from the detachable connection is hinged or elastically connected.

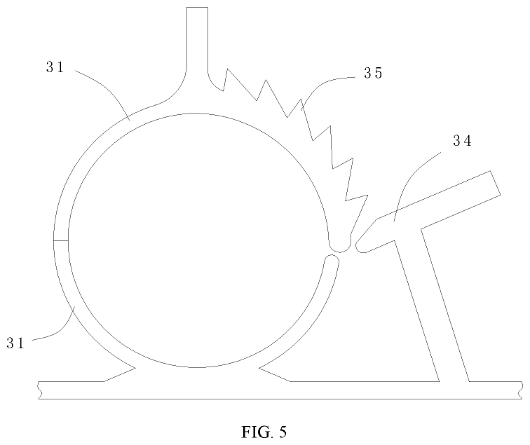

As shown in FIG. 1, the two pressing portions 31 are connected in a hinging form, to achieve the automatic pop-up of the pressing portions 31, a reset spring, such as a coil spring or a torsional spring may be arranged at a hinging position. As shown in FIG. 5, which shows an elastic connecting mode of the two pressing portions 31, the two pressing portions 31 are integrally formed and the above pressing portion 31 may make use of the elastic deformation of the material, and the latches 35 are fixed to the fixture block 34 by rotating the above pressing portion 31, thus implementing the regulation and fixation for the degree of compaction of the pressing portions 31. By adopting the elastic connecting mode, the two containing portions may be arranged on the two pressing portions 31 to place the intubation tube, or two structures as shown in FIG. 5 are arranged on the fitting component 2.

A pressing column 33 is arranged inside one pressing portion 31 and at least two groups of limiting columns 36 are arranged inside the other pressing portion 31, both the pressing column 33 and the limiting columns 36 are protruded from the containing portion, and the pressing column 33 is located between the two groups of limiting columns 36. The two groups of limiting columns 36 are arranged to limit the position of the inserted pipeline, such that the pipeline cannot swing left and right, and then the pipeline is pressed and fixed through the pressing column 35, thus further increasing the fixing effect of the pipeline.

The connecting portion 1 includes strip plates 11 connected with the fitting component 2, and the strip plates 11 are connected with bandages. The strip plates 11 are provided with the connecting holes 14, and the bandages may be wound from the connecting holes 14 and bundled and fixed, thus increasing the fixing effect of the bandages. The bandages may be set to elastic bands or cotton bands.

Bending portions are arranged in the strip plates 11 and extend to auricle. The fixing device for the bandages is guided above the auricle through the bending portions of the strip plates 11, such that the bandages may be limited by the auricle after being bundled and fixed, to avoid the displacement generated by the fixing device due to the moving-down of the bandage.

The strip plates 11 are connected with at least one limiting member 12, and a channel, through which the intubation pipeline passes, is arranged in the limiting member 12, one side of the limiting member 12 is provided with an opening, at least two limiting members 12 are provided, and openings of the limiting members 12 are located on both sides of the strip plates 11 in respective. An opening structure is arranged such that the pipeline is mounted from sides of the limiting members 12 and enters to the channel for the limiting members 12, which is convenient for pipeline disassembly while being convenient for the pipeline arrangement. The intubation pipeline is guided and limited by setting a plurality of limiting members 12 with inconsistent opening positions, such that the pipeline is arranged along both sides or one side of the patient's cheek, to implement the platform aloft method in the background art and ensure the using effect of the intubation tube.

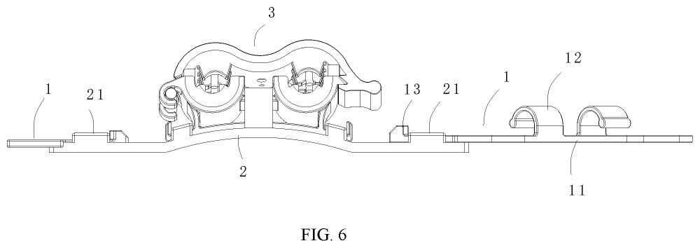

When only one pipeline needs to enter the nasal cavity of the patient, to save the material and using cost, the limiting members 12 for fixing the pipeline may be arranged on the connecting portion 1 on one side only, as shown in FIG. 6, the connecting portion 1 on the other side is replaced by the connecting portion 1 without the limiting members 12, and the size of this connecting portion 1 is reduced.

One pressing portion 31 and the strip plates 11 are detachably connected with the fitting component 2, a plurality of connecting seats 21 are arranged on the fitting component 2 and provided with the plugging holes, both ends of the pressing portions 31 connected with the fitting component 2 is provided with second protrusion portions 32 after passing through the plugging holes, and one end of each of the strip plates 11 that is connected with the fitting component 2 is provided with a first protrusion portions 13 after passing through the plugging holes. The first protrusion portion 13 and the second protrusion portion 32 are arranged, such that the pressing portions 31 and the strip plates 11 play a limiting role after passing through the connecting seats 21, the fitting component 2 is made of a soft material and the connecting seats 21 thereof are also made of the soft material, and when the fixing frame 3 and the connecting portion 1 need to be disassembled, the connecting seats 21 deform to extract the first protrusion portion 13 and the second protrusion portion 32, thus achieving the quick disassembly.

The containing portions are obliquely arranged along a direction of nares. The containing portions obliquely aiming at the nares enable the intubation tube to keep an angle with the nares, thus reducing the mechanical stimulation on the nasal cavity due to the pipeline bending during intubation operation.

The fitting component 2 is made of silica gel. The fitting component 2 made of silica gel may improve the comfort of the face fitting part while ensuring a better static friction force.

Using process: the fitting component 2 is placed at the philtrum below the nares and bundled and fixed to the patient's head through the bandages, thus achieving the fixation for the fixing device. One pressing portion 31 is opened, the intubation pipeline is placed in the containing portions, then the above pressing portion 31 is covered, the two pressing portions 31 are fixed through the fit of the latches 35 and the fixture block 34, and the pipeline is clamped and fixed by the two fixed pressing portions 31.

The pipeline outside the nares is arranged along the strip plates 11 on both sides of the cheek, then the pipeline is pressed to the channel for the limiting members 12 from the opened side, that is, the arrangement and fixation for the pipeline may be completed conveniently.

The above is only preferred embodiments of the present disclosure and is not intended to limit the present disclosure. Those skilled in the art may make various modifications and variations. Any modifications, equivalent replacements, improvements and the like made within the spirit and principle of the present disclosure shall fall within the scope of protection of the present disclosure.

What is claimed is:

1. A fixing device for double-tube intubation, comprising a fitting component and a fixing frame arranged on the fitting component, wherein
both ends of the fitting component are connected with a connecting portion, through which the fitting component is fixed to philtrum below nares, the fixing frame comprises at least two pressing portions, one end of each of the pressing portions is connected mutually while the other end is in mutual opening and closing connection, and containing portions for placing an intubation pipeline are arranged between the two pressing portions.

2. The fixing device for double-tube intubation according to claim 1, wherein at opening and closing connecting ends of the pressing portions, one end of one of the pressing portions is equipped with latches, and one end of the other pressing portion is equipped with a fixture block that fits with the latches and is in opening and closing connection.

3. The fixing device for double-tube intubation according to claim 1, wherein the two pressing portions are arranged in a form of upper and lower structures, and divided into an upper pressing portion and a lower pressing portion;
a pressing section of the upper pressing portion is wavy and formed with two arc-shaped upper pressing slots with downward openings; and the lower pressing portion is provided with a base, correspondingly to each upper pressing slot of an upper pressing section, the base is provided with a corresponding arc-shaped lower pressing slot, and the upper pressing slots and the lower pressing slots form the containing portions for placing the intubation pipeline;
wherein a link that is lower than a lower pressing notch portion is arranged between the two lower pressing slots of the lower pressing portion, both ends of the base are provided with protrusion portions raised upwards, a plurality of connecting seats are arranged on the fitting component and provided with plugging holes, both ends of the base connected with the fitting components is clamped and fixed through the protrusion portions after passing through the plugging holes of the connecting seats, another connecting seat is also provided between the above two connecting seats, and the lower pressing portion passes through the plugging hole of the another connecting seat from one end, such that the link is clamped with the another connecting seat, thus fixing the pressing portions from the middle of the base.

4. The fixing device for double-tube intubation according to claim 2, wherein a plurality of latches are provided.

5. The fixing device for double-tube intubation according to claim 1, wherein one end of each of the pressing portions that is away from the opening and closing connection end is hinged or elastically connected.

6. The fixing device for double-tube intubation according to claim 1, wherein a pressing column is arranged inside one pressing portion and at least two groups of limiting columns are arranged inside the other pressing portion, both the pressing column and the limiting columns are protruded from the containing portion, and the pressing column is located between the two groups of limiting columns.

7. The fixing device for double-tube intubation according to claim 1, wherein the connecting portion comprises strip plates connected with the fitting component, and the strip plates are connected with bandages.

8. The fixing device for double-tube intubation according to claim 7, wherein bending portions are arranged in the strip plates and extend to auricle.

9. The fixing device for double-tube intubation according to claim 7, wherein the strip plates are connected with at least one limiting member, and a channel, through which the intubation pipeline passes, is arranged in the limiting member.

10. The fixing device for double-tube intubation according to claim 9, wherein one side of the limiting member is provided with an opening.

11. The fixing device for double-tube intubation according to claim 10, wherein at least two limiting members are provided, and openings of the limiting members are located on both sides of the strip plates in respective.

12. The fixing device for double-tube intubation according to claim 7, wherein one pressing portion is detachably connected with the fitting component, and the strip plates are detachably connected with the fitting component.

13. The fixing device for double-tube intubation according to claim 12, wherein a plurality of connecting seats are arranged on the fitting component and provided with the plugging holes, both ends of the pressing portions connected with the fitting component are provided with second protrusion portions after passing through the plugging holes, and one end of each of the strip plates that is connected with the fitting component is provided with a first protrusion portion after passing through the plugging holes.

14. The fixing device for double-tube intubation according to claim 1, wherein the containing portions are obliquely arranged along a direction of nares.

15. The fixing device for double-tube intubation according to claim 1, wherein the fitting component is made of silica gel.
